(19) United States
(12) Patent Application Publication
(10) Pub. No.: US 2016/0298269 A1
(43) Pub. Date: Oct. 13, 2016

(54) SOLVENT EXTRACTION APPARATUS

(71) Applicant: DONGYANG MFG CO., LTD., Busan (KR)

(72) Inventors: Jae Hyuk CHA, Busan (KR); Sung Soo PARK, Busan (KR); Gyoung Suk KIM, Busan (KR)

(21) Appl. No.: 15/100,383

(22) PCT Filed: Nov. 28, 2014
(86) PCT No.: PCT/KR2014/011534

§ 371 Date: May 31, 2016

(30) Foreign Application Priority Data
Dec. 2, 2013 (KR) 10-2013-0148559

(51) Int. Cl. D01F 13/00; D01D 10/06; D01D 5/06; B01D 12/00

(52) U.S. Cl. CPC D01F 13/00; B01D 12/00; D01D 10/06; D01D 5/06

(57) ABSTRACT

A solve extraction apparatus includes a solvent extraction unit for extracting a first solvent contained in a gel material, wherein the solvent extraction unit is divided by at least one partition wall, includes multiple extraction baths each accommodating a second solvent, the first solvent contained in the gel material being extracted by the second solvent while moving in the multiple extraction baths.

### TECHNICAL FIELD

Embodiments of the present invention relate to a solvent extraction apparatus, and more particularly, to a solvent extraction apparatus for extracting a first solvent contained in a gel material.

### BACKGROUND ART

Generally, methods for producing textiles include an ultrahigh elongation method, a solid state extrusion method, a band elongation method, a gel spinning method, etc.

However, among them, the gel spinning method capable of performing mass-production is generally used. According to the gel spinning method, a first solvent and a polymer resin are stirred, mixed, and cooled to form gel fibers and then the first solvent is extracted from the gel fibers. Here, the gel fibers enter an extraction bath in which a second solvent is contained to extract the first solvent from the gel fibers. Since a specific gravity of the second solvent is greater than a specific gravity of the first solvent, the first solvent extracted from the gel fibers floats on a surface of the extraction bath. Also, when the first solvent is extracted from the gel fibers, foreign substances such as a small amount of water, dust, an antioxidant, etc. are also extracted and float on the surface of the extraction bath.

### PRIOR ART DOCUMENT

Korean Patent Publication No. 1985-0002488 (May 13, 1985)

### DISCLOSURE

### Technical Problem

Embodiments of the present invention provide a solvent extraction apparatus capable of improving extraction efficiency of a first solvent contained in a gel material.

Embodiments of the present invention provide a solvent extraction apparatus capable of easily discharging foreign substances which contain a first solvent extracted from a gel material outward.

### Technical Solution

One aspect of the present invention provides a solvent extraction apparatus including a solvent extraction unit which extracts a first solvent contained in a gel material. The solvent extraction unit includes a plurality of extraction baths partitioned by at least one partition wall and each containing a second solvent, in which the first solvent contained in the gel material is extracted by the second solvent while passing through the plurality of extraction baths.

The solvent extraction apparatus may further include and a foreign substance collecting portion formed in at least one of the plurality of extraction baths, in which heights of the partition walls may increase as the partition walls recede from an extraction bath in which the foreign substance collecting portion is formed.

An upper end of the foreign substance collecting portion may be formed to be higher than a level of the second solvent in the extraction bath in which the foreign substance collecting portion is formed.

The foreign substance collecting portion may have a cross section which narrows from the upper end to a lower end of the foreign substance collecting portion.

The solvent extraction apparatus may further include a foreign substance discharge portion which is connected to the foreign substance collecting portion and discharges foreign substances extracted from the gel material and collected at the foreign substance collecting portion.

In the extraction bath in which the foreign substance collecting portion is formed, an outside of the foreign substance collecting portion may be filled with the second solvent.

The gel material may move sequentially through the plurality of extraction baths and may move in the extraction bath in which the foreign substance collecting portion is formed toward an outside of the foreign substance colleting portion.

The solvent extraction apparatus may additionally supply the second solvent to the extraction bath with a highest partition wall to sequentially overflow foreign substances extracted from the gel material into the extraction bath in which the foreign substance colleting portion is formed.

The foreign substances which contain the first solvent may be extracted from each of the plurality of extraction baths and the second solvent may be formed of a material having a specific gravity higher than that of the foreign substances.

The gel material may be monofilaments in the form of gel fibers.

### Advantageous Effects

According to the embodiments of the present invention, since a plurality of extraction baths are formed using partition walls, a first solvent contained in a gel material such as gel fibers or gel films, etc. may be extracted through several stages, thereby improving extraction efficiency of the first solvent contained in the gel material. Also, heights of the partition walls among the extraction baths increase as receding from an extraction bath in which a foreign substance collecting portion is formed, thereby collecting foreign substances floating on surfaces of other extraction baths at the extraction bath in which the foreign substance colleting portion is formed and easily discharging the foreign substances through a foreign substance discharge portion connected to the foreign substance collecting portion. Also, it is possible to simplify a system for removing the foreign substances floating on a surface of each of the extraction baths simply through forming the foreign substance colleting portion in at least one of the plurality of extraction baths and increasing the heights of the partition walls to as they recede from the extraction bath in which the foreign substance collecting portion is formed.

### BRIEF DESCRIPTION OF DRAWINGS

FIG. 1 is a schematic diagram of a fiber producing apparatus including a solvent extraction unit according to one embodiment of the present invention.

FIG. 2 is a view of the solvent extraction unit according to one embodiment of the present invention.

FIG. 3 is a view illustrating a state in which foreign substances are discharged outward from the solvent extraction unit according to one embodiment of the present invention.

FIG. 4 is a view of a solvent extraction unit according to another embodiment of the present invention.

### MODE FOR INVENTION

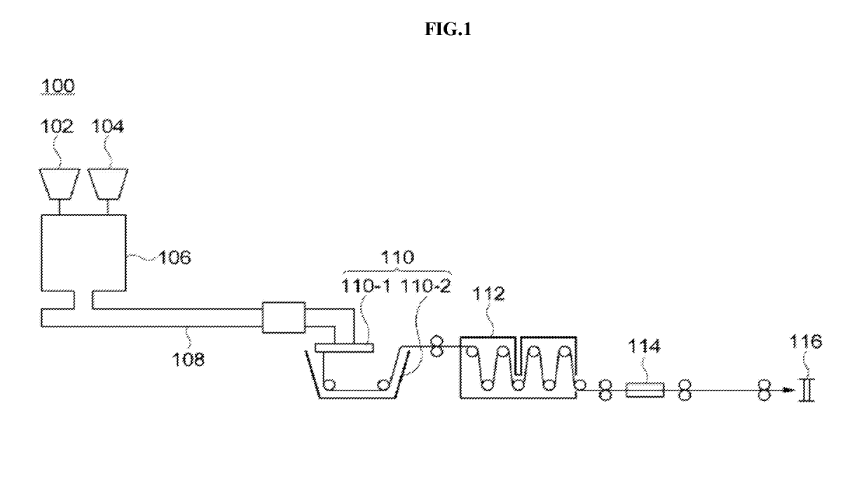

Hereinafter, referring to FIGS. 1 to 4, a solvent extraction apparatus according to exemplary embodiments of the present invention will be described. However, they are merely exemplary embodiments and the present invention is not limited thereto.

In the description of embodiments, certain detailed explanations of the related art are omitted when it is deemed that they may unnecessarily obscure the essence of the present invention. Also, terms described below are defined considering functions thereof in the embodiments, which may vary with a user, an intention of an operator, or a practice. Accordingly, definitions thereof should be given based on the content of the entire specification.

The technical concept of the present invention is defined by the claims. The following embodiments are used merely to efficiently explain the inventive technical concept of the present invention to one of ordinary skilled in the art.

FIG. 1 is a schematic diagram of a fiber producing apparatus including a solvent extraction unit according to one embodiment of the present invention. Here, although the fiber producing apparatus is described as one embodiment, the present invention is not limited thereto, and may applied to various additional apparatuses which each include processes of forming intermediate goods in the form of a gel by a first solvent entering a raw material and extracting the first solvent from the intermediate material in the form of a gel, for example, a film manufacturing apparatus, etc.

Referring to FIG. 1, a fiber producing apparatus 100 includes a first supply unit 102, a second supply unit 104, a mixer 106, a melt extruder 108, a gel fiber forming unit 110, a solvent extraction unit 112, a drawing unit 114, and a winding unit 116.

The first supply unit 102 supplies a preset amount of a first solvent to the mixer 106. The first solvent may be a solvent capable of dissolving polymer resins. The first solvent may be a hydrocarbon-based solvent, for example, petroleum-based mineral oils, mineral oils, etc. However, the first solvent is not limited thereto and may be one of various other solvents such as paraffin oil, xylene, toluene, trichlorobenzene, etc.

The second supply unit 104 supplies a polymer resin to the mixer 106 to be at a preset weight ratio with respect to the first solvent. For example, when the polymer resin is polyethylene, the second supply unit 104 may supply polyethylene to the mixer 106 to be at a weight ratio of 5 to 20 weight % with respect to 100 weight % of the first solvent. Here, polyethylene which is the polymer may be a homopolymer formed of only ethylene as a repeating unit or may be a copolymer formed of ethylene as a repeating unit and a small amount of another monomer which is copolymerized. Here, polyethylene has been described as an example of the polymer resin, but the polymer resin is not limited thereto and various other polymer resins may be used.

The mixer 106 stirs and mixes the first solvent supplied from the first supply unit 102 with the polymer resin supplied from the second supply unit 104 thereby obtaining a gelated solution. For example, the mixer 106 may obtain a mixed liquid in the form of a slurry by stirring the first solvent and the polymer resin at a preset temperature and may obtain a gelated solution by rotating the mixed liquid in the form of the slurry. The mixer 106 may discharge the gelated solution into the melt extruder 108.

The melt extruder 108 extrudes the gelated solution discharged from the mixer 106 while maintaining a melted state thereof. Here, the melt extruder 108 may include a heater (not shown) for maintaining the melted state of the gelated solution. The melt extruder 108 may discharge a portion of the first solvent contained in the gelated solution while extruding the gelated solution. Here, the portion of the first solvent discharged from the melting-extruder 108 may be stored in a reclaiming bath (not shown) and then supplied to the first supply unit 102 to be reused.

The gel fiber forming unit 110 obtains gel fibers, that is, gel intermediate goods, by spinning the melted-extruded gelated solution. The gel fiber forming unit 110 includes a spinning portion 110-1 which spins the melt-extruded gelated solution and a cooling vat 110-2 which cools the spun gleated solution. The spinning portion 110-1 includes a plurality of nozzles having a certain length and diameter. The gelated solution melt-extruded from the melt extruder 108 is discharged by passing through each of the nozzles of the spinning portion 110-1. The cooling vat 110-2 cools gel fibers formed by the spinning of the spinning portion 110-1.

The solvent extraction unit 112 extracts the first solvent from the gel fibers. For example, the solvent extraction unit 112 may extract the first solvent from the gel fibers by impregnating the gel fibers with a second solvent contained in an extraction bath. Here, the first solvent contained in the gel fibers is extracted by the second solvent in the extraction bath. The second solvent may be, for example, any one or a combination of two or more of trichloroethane, trifluroethane, normal hexane, and ethane, but is not limited thereto, and may vary according to a type of the first solvent.

When the first solvent contained in the gel fibers is extracted in the extraction bath in which the second solvent is contained, the first solvent, a small amount of water, and foreign substances such as an antioxidant, etc. are extracted from the gel fibers. Here, since a specific gravity of the second solvent is greater than those of the foreign substances, the foreign substances float on a surface of the extraction bath. Here, when the foreign substances are floating on the surface of the extraction bath, the foreign substances are moved by being on the gel fibers while the gel fibers are moved from the solvent extraction unit 112 to the drawing unit 114. Accordingly, in the embodiment of the present invention, the solvent extraction unit 112 is formed of a plurality of such extraction baths and foreign substances floating on a surface of each of the extraction baths are collected into at least one extraction bath and then removed. This will be described below in detail.

The drawing unit 114 draws the gel fibers, from which the first solvent is extracted, at a preset drawing ratio and obtains fibers to be manufactured using the fiber producing apparatus 100. Here, the gel fibers, from which the first solvent is extracted, may be washed in a washing tub (not shown) and then may be drawn by the drawing unit 114.

The winding unit 116 rotates at a preset speed and winds the fibers drawn by the drawing unit 114.

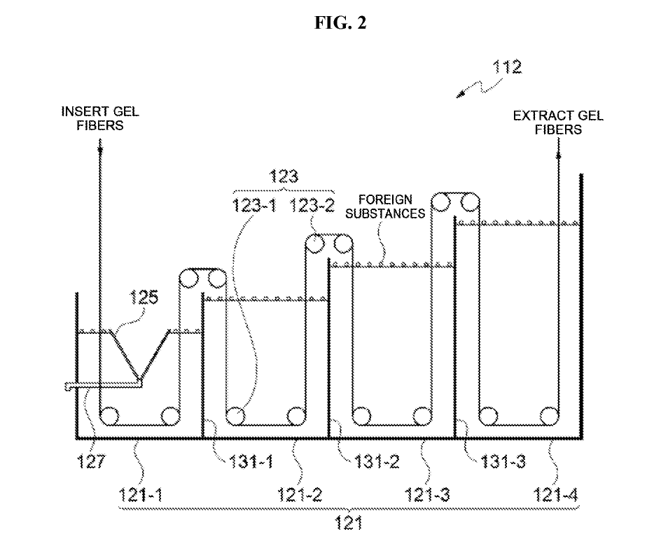

FIG. 2 is a view of the solvent extraction unit according to one embodiment of the present invention.

Referring to FIG. 2, the solvent extraction unit 112 includes extraction baths 121, transfer rollers 123, a foreign substance collecting portion 125, and a foreign substance discharge portion 127.

The extraction baths 121 may include a first extraction bath 121-1, a second extraction bath 121-2, a third extraction bath 121-3, and a fourth extraction bath 121-4. Here, the four extraction baths 121-1, 121-2, 121-3, and 121-4 are shown but the number of extraction baths is not limited thereto, and there may be various numbers of extraction baths. In each of the extraction baths 121-1, 121-2, 121-3, and 121-4, the second solvent for extracting the first solvent from the gel fibers, that is, gel intermediate goods, is contained.

Partition walls 131-1, 131-2, and 131-3 are formed between adjacent extraction baths 121-1, 121-2, 121-3, and 121-4 to partition them. For example, a first partition wall 131-1 is formed between the first extraction bath 121-1 and the second extraction bath 121-2, a second partition wall 131-2 is formed between the second extraction bath 121-2 and the third extraction bath 121-3, and a third partition wall 131-3 is formed between the third extraction bath 121-3 and the fourth extraction bath 121-4.

The transfer rollers 123 transfer the gel fibers among the extraction baths 121-1, 121-2, 121-3, and 121-4. The transfer rollers 123 include lower transfer rollers 123-1 and upper transfer rollers 123-2. The lower transfer rollers 123-1 may be formed in each of the extraction baths 121-1, 121-2, 121-3, and 121-4. Here, each of the lower transfer rollers 123-1 may transfer the gel fibers in the corresponding extraction baths 121-1, 121-2, 121-3, and 121-4. The upper transfer rollers 123-2 may be formed above each of the extraction baths 121-1, 121-2, 121-3, and 121-4. Here, each of the upper transfer rollers 123-2 may transfer the gel fibers from one extraction bath to another extraction bath adjacent thereto.

The foreign substance collecting portion 125 may be formed in at least one of a plurality of such extraction baths 121-1, 121-2, 121-3, and 121-4. For example, the foreign substance collecting portion 125 may be formed in the first extraction bath 121-1 which the gel fibers enter. When the foreign substance collecting portion 125 is formed in the first extraction bath 121-1, heights of the partition walls 131-1, 131-2, and 131-3 may increase as they recede from the first extraction bath 121-1. That is, from the first partition wall 131-1 to the third partition wall 131-3, the heights thereof may increase.

The foreign substance collecting portion 125 may have an upper end higher than a level of the second solvent in the first extraction bath 121-1. An outside of the foreign substance collecting portion 125 in the first extraction bath 121-1 is filled with the second solvent. The foreign substance collecting portion 125 may have a shape with a cross section which narrows from the upper end to a lower end thereof. For example, the foreign substance collecting portion 125 may have a funnel shape. Here, the foreign substance collecting portion 125 may have various shapes such as an inverted cone shape, an inverted triangular pyramid shape, an inverted quadrangular pyramid shape, an inverted pentagonal pyramid shape, etc. Here, when the level of the second solvent in the first extraction bath 121-1 is higher than that of the upper end of the foreign substance collecting portion 125, foreign substances floating on the surface of the first extraction bath 121-1 overflow to the foreign substance collecting portion 125 and move downward along an inside of the foreign substance collecting portion 125.

The foreign substance discharge portion 127 may be formed by being interconnected with the foreign substance collecting portion 125. For example, one side of the foreign substance discharge portion 127 may be connected to the lower end of the foreign substance collecting portion 125, and the other side of the foreign substance discharge portion 127 may be connected to an external space. In this case, the foreign substance discharge portion 127 may discharge the foreign substances collected at the foreign substance collecting portion 125 outward.

Here, when the gel fibers enter the first extraction bath 121-1, the gel fibers are transferred through the transfer rollers 123 sequentially from the first extraction bath 121-1 to the fourth extraction bath 121-4. When the gel fibers move inside the first extraction bath 121-1, the gel fibers may move outside the foreign substance collecting portion 125. Since the second solvent is contained in each of the extraction baths 121-1, 121-2, 121-3, and 121-4, while the gel fibers move inside each of the extraction baths 121-1, 121-2, 121-3, and 121-4, the first solvent contained in the gel fibers is extracted. Here, 70% or more of the first solvent contained in the gel fibers is extracted while passing through the first extraction bath 121-1 and the rest is extracted while sequentially passing through the second extraction bath 121-2 to the fourth extraction bath 121-4. As described above, since the extraction baths 121 are divided by the partition walls 131-1, 131-2, and 131-3, the first solvent contained in the gel fibers may be extracted through several stages, thereby improving extraction efficiency of the first solvent contained in the gel fibers. Here, the gel fibers may be monofilaments. Since the monofilaments have a great thickness when having the same denier as those of multifilaments, it is difficult to extract the first solvent. However, according to the embodiment of the present invention, since the first solvent is extracted through several stages in the extraction baths 121, the extraction efficiency of the first solvent may be increased even in the case of the monofilaments. However, the gel fibers are not limited to the monofilaments but may be applied as multifilaments. The gel fibers moving out of the fourth extraction bath 121-4 may go through a washing process and may be inserted into the drawing unit 114. Also, when the first solvent is extracted from the gel fibers in each of the extraction baths 121-1, 121-2, 121-3, and 121-4, a small amount of water, dust, an antioxidant, etc. are also extracted from the gel fibers in such a way that the first solvent and the foreign substances such as the small amount of water, dust, the antioxidant, etc. float on the surface of each of the extraction baths 121-1, 121-2, 121-3, and 121-4.

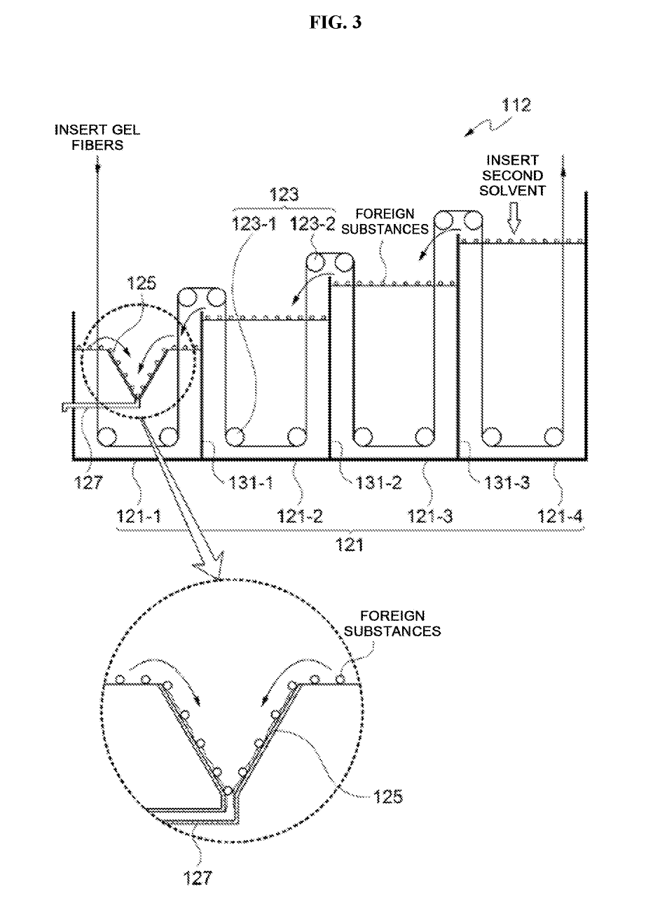

FIG. 3 is a view illustrating a state in which foreign substances are discharged outward from the solvent extraction unit according to one embodiment of the present invention.

Referring to FIG. 3, the second solvent is additionally supplied to the fourth extraction bath 121-4 in order to collect foreign substances floating on the surfaces of the fourth extraction bath 121-4, the third extraction bath 121-3, and the second extraction bath 121-2. Then, the foreign substances floating on the surface of the fourth extraction bath 121-4 overflow with the second solvent to the third extraction bath 121-3. Also, when the second solvent is continuously supplied to the fourth extraction bath 121-4, the foreign substances floating the surface of the third extraction bath 121-3 overflow with the second solvent to the second extraction bath 121-2, and then the foreign substances floating on the surface of the second extraction bath 121-2 overflow with the second solvent to the first extraction bath 121-1.

In addition, when the second solvent is continuously supplied to the fourth extraction bath 121-4, the foreign substances floating on the surface of the first extraction bath 121-1 overflow with the second solvent to the foreign substance collecting portion 125. Since the foreign substance collecting portion 125 is formed in a shape with a cross section which narrows from the upper end to the lower end, the foreign substances which overflow to the foreign substance collecting portion 125 are collected at the lower end of the foreign substance collecting portion 125, and the foreign substances which are collected at the lower end of the foreign substance collecting portion 125 are discharged through the foreign substance discharge portion 127.

As described above, since the heights of the partition walls among the extraction baths 121-1, 121-2, 121-3, and 121-4 increase as they recede from the first extraction bath 121-1 at which the foreign substance collecting portion 125 is formed, the foreign substances floating on the surfaces of the fourth extraction bath 121-4, the third extraction bath 121-3, and the second extraction bath 121-2 are collected at the first extraction bath 121-1, thereby easily discharging the foreign substances outward from the first extraction bath 121-1 through the foreign substance collecting portion 125 and the foreign substance discharge portion 127. Also, a system for removing the foreign substances floating the surface of each of the extraction baths 121-1, 121-2, 121-3, and 121-4 may be simplified by forming the foreign substance collecting portion 125 in at least one extraction bath and allowing the heights of the partition walls among the extraction baths 121-1, 121-2, 121-3, and 121-4 to increase as they recede from the extraction bath in which the foreign substance collecting portion 125 is formed.

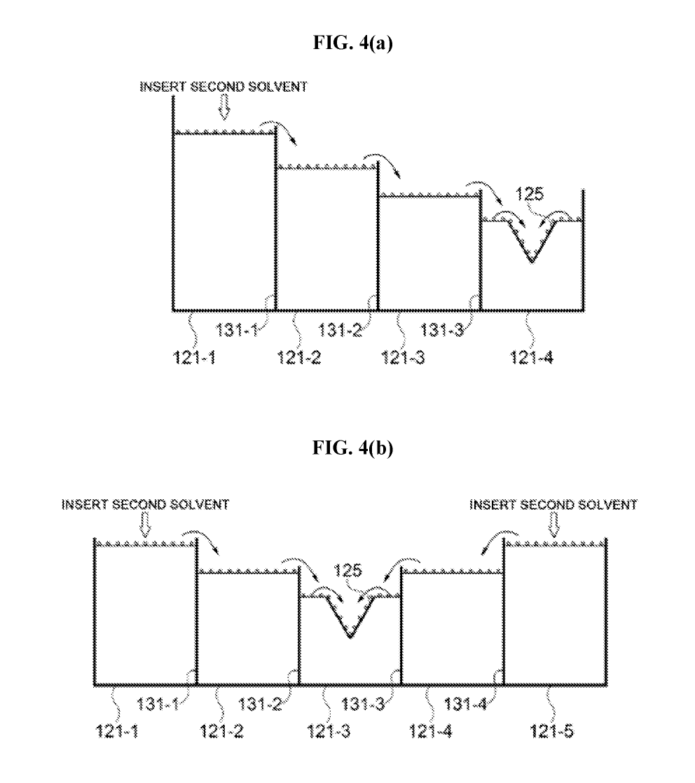

FIG. 4 is a view of a solvent extraction unit according to another embodiment of the present invention. Here, for convenience of description, the transfer rollers 123 and the foreign substance discharge portion 127 are omitted.

Referring to FIG. 4(a), when gel fibers enter the first extraction bath 121-1 and are sequentially transferred to the fourth extraction bath 121-4, the foreign substance collecting portion 125 may be formed at the fourth extraction bath 121-4. In this case, heights of the partition walls 131-1, 131-2, and 131-3 may increase as they recede from the fourth extraction bath 124-4. That is, from the third partition wall 131-3 to the first partition wall 131-1, the heights thereof may increase. Here, when a second solvent is additionally inserted into the first extraction bath 121-1, the second solvent sequentially overflows from the first extraction bath 121-1 to the third extraction bath 121-3, thereby collecting foreign substances at the fourth extraction bath 121-4. Here, when the second solvent continuously enters the first extraction bath 121-1, foreign substances floating on the surface of the fourth extraction bath 121-4 overflow with the second solvent to the foreign substance collecting portion 125 and are discharged outward through a foreign substance discharge portion (not shown).

Referring to FIG. 4(b), when the extraction baths 121 include the first extraction bath 121-1 to a fifth extraction bath 121-5, the foreign substance collecting portion 125 may be formed at the third extraction bath 121-3. In this case, heights of partition walls 131-1, 131-2, 131-3, and 131-4 may increase as they recede from the third extraction bath 121-3. That is, a height of a fourth partition wall 131-4 may be greater than the height of the third partition wall 131-3, and the height of the first partition wall 131-1 may be greater than the height of the second partition wall 131-2. Then, when the second solvent is additionally supplied to the first extraction bath 121-1 and the fifth extraction bath 121-5, all foreign substances floating on surfaces of the first extraction bath 121-1, the second extraction bath 121-2, the fourth extraction bath 121-4, and the fifth extraction bath 121-5 are collected at the third extraction bath 121-3, overflow from the third extraction bath 121-3 to the foreign substance collecting portion 125, and are discharged outward through a foreign substance discharge portion (not shown).

Here, the foreign substance collecting portion 125 is shown as being formed at any one of a plurality of extraction baths but is not limited thereto, and may be formed at two or more extraction baths. For example, when a plurality of extraction baths are formed by partition walls, a first foreign substance collecting portion may be formed at an extraction bath located at one end of the plurality of extraction baths, and a second foreign substance collecting portion may be formed at an extraction bath located at the other end of the plurality of extraction baths. In this case, heights of the partition walls may increase as they recede from the extraction bath at which the first foreign substance collecting portion is formed, that is, from the extraction bath located at the one end with respect to a center of the plurality of extraction baths, and the heights of the partition walls may increase as they recede from the extraction bath at which the second foreign substance collecting portion is formed, that is, from the extraction bath located at the other end to the center of the plurality of extraction baths.

In the specification, a case in which fibers are produced using a gel spinning method or a gel method is shown as one embodiment, but the present invention is not limited thereto. The present invention may be applied to all various fiber producing methods, for example, a solvent spinning method, which include a process in which a first solvent enters a raw thread material and are extracted, that is, reclaiming, the same during a process of producing fibers. Materials to which the present invention is applied may include, for example, high molecular weight polyethylene, aramid, acetate, polyvinyl alcohol, para-phenylene benzoobisoxazole (PBO), liquid crystal polymer threads, polyacrylonitrile, etc. but are not limited thereto, and may include various materials capable of being used for producing fibers using the gel spinning method or the gel method. Also, in the specification, a case in which a first solvent is extracted from gel fibers has been described as the embodiment, but the embodiments are not limited thereto. The present invention may be applied to various producing apparatuses which include processes of forming intermediate goods in the form of a gel by a first solvent entering a raw material and extracting the first solvent from the intermediate goods in the form of the gel. For example, the present invention may be applied to a film manufacturing apparatus which includes processes of forming films in the form of a gel by a first solvent entering a raw material and extracting the first solvent from gel films.

While the inventive concept has been particularly shown and described with reference to embodiments thereof, it should be understood that various changes in form and details may be made therein without departing from the spirit and scope of the following claims. Therefore, the scope of the present invention is not limited to the embodiments described above but should be defined by the following claims and equivalents thereof

[Brief Description of Reference Numerals]

| | |
|---|---|
| 100: Fiber producing apparatus | 102: First supply unit |
| 104: Second supply unit | 106: Mixer |
| 108: Melt extruder | |
| 110: Gel fiber forming unit | 110-1: Spinning portion |
| 110-2: Cooling vat | 112: Solvent extraction unit |
| 114: Drawing unit | 116: Winding unit |
| 121: Extraction baths | 123; Transfer rollers |
| 125: Foreign substance collecting | 127: Foreign substance discharge |
| portion | portion |
| 131: Partition walls | |

1. A solvent extraction apparatus comprising:
a solvent extraction unit which comprises a plurality of extraction baths partitioned by at least one partition wall and each containing a second solvent, in which a first solvent contained in a gel material is extracted by the second solvent while passing through the plurality of extraction baths; and
a foreign substance collecting portion formed in at least one of the plurality of extraction baths,
wherein heights of the partition walls increase as the partition walls recede from the extraction bath in which the foreign substance collecting portion is formed.

2. The solvent extraction apparatus of claim 1, wherein an upper end of the foreign substance collecting portion is formed to be higher than a level of the second solvent in the extraction bath in which the foreign substance colleting portion is formed.

3. The solvent extraction apparatus of claim 2, wherein the foreign substance collecting portion has a cross section which narrows from the upper end to a lower end of the foreign substance collecting portion.

4. The solvent extraction apparatus of claim 1, further comprising a foreign substance discharge portion which is connected to the foreign substance collecting portion and discharges foreign substances extracted from the gel material and collected at the foreign substance collecting portion.

5. The solvent extraction apparatus of claim 1, wherein in the extraction bath in which the foreign substance collecting portion is formed, an outside of the foreign substance collecting portion is filled with the second solvent.

6. The solvent extraction apparatus of claim 1, wherein the gel material moves sequentially through the plurality of extraction baths and moves in the extraction bath in which the foreign substance collecting portion is formed toward an outside of the foreign substance colleting portion.

7. The solvent extraction apparatus of claim 1, wherein the second solvent is additionally supplied to an extraction bath with a highest partition wall to sequentially overflow foreign substances extracted from the gel material into the extraction bath in which the foreign substance colleting portion is formed.

8. The solvent extraction apparatus of claim 1, wherein foreign substances which contain the first solvent are extracted from each of the plurality of extraction baths and the second solvent is formed of a material having a specific gravity higher than that of the foreign substances.

9. The solvent extraction apparatus of claim 1, wherein the gel material is monofilaments in the form of gel fibers.
